(19) United States
(12) Patent Application Publication
(10) Pub. No.: US 2010/0109250 A1
(43) Pub. Date: May 6, 2010

(54) Dynamic sealing element

(76) Inventor: Werner Hueck, Lahnau (DE)

Correspondence Address: DENNISON, SCHULTZ & MACDONALD, 1727 KING STREET, SUITE 105, ALEXANDRIA, VA, 22314, US

(21) Appl. No.: 12/289,798

(22) Filed: Nov. 4, 2008

(51) Int. Cl. F16J 15/34; B23P 11/00

(52) U.S. Cl. 277/370; 29/428

(57) ABSTRACT

The invention relates to a sliding seal (12) made of a carbon and/or graphite material having a sliding surface. To simplify the manufacturing process without any loss of sealing effect, it is proposed that the sealing surface (18) of the unused sliding seal (12) should have at least one peripheral protrusion (20) that is supportable on a surface (14) to be sealed and serves as the breaking-in aid.

The present invention relates to a dynamic sealing element, intended in particular for a steam head gasket, with a base body having a contact face, whereby the contact face is in surface contact with a surface to be sealed after breaking in. Furthermore, the invention relates to a method for forming a contact face of a dynamic sealing element which develops out of a base body and is in surface contact with a surface to be sealed after breaking in.

DE-C-482 546 discloses a coupling for a steam line having a loose sealing ring between the opposing end faces of one-half of the coupling which is stationary and another half of the coupling which is rotating. The coupling ring is provided with a sealing face perpendicular to the axis of rotation and with a curved sealing face and is made at least in part of carbon or pressed graphite.

The subject matter of DE-C-332 831 is a sealing disk for sealing the bearing of a crankshaft with respect to a crankcase. The sealing disk has ring-shaped sealing strips which become wider in terms of their basic area and which rapidly wear up to a certain limit in breaking in the machines. The sealing strips then ensure a tight contact with the housing wall.

A sealing element for a bearing according to DE-A-1 750 294 comprises two ring-shaped pressed parts that are rotatable relative to one another and have oppositely directed contact sealing faces.

DE-A-197 09 369 discloses a machine for making paper webs or cardboard webs in which a heatable roller is supported over a loose bearing.

To seal rotating systems such as rollers or drums with respect to pressurized lines carrying hot or cold water or heating medium oils, for example, steam head gaskets or feed head gaskets are used. The construction of such gaskets must be designed so that in addition to a rotating movement, vibrational movements, pendulum movements and tumbling movements are also made possible, all of which may occur in sealing the corresponding systems. This is done by using primarily carbon sealing rings having a convex or concave contact surface. Sealing elements in this regard must run without interruption and without maintenance for long periods of time, e.g., in the paper and pulp industry.

To achieve the desired sealing effect, complex manufacturing steps are necessary because surface contact of the sealing element with a surface to be sealed must be ensured to prevent liquids or gases from escaping. Usually the sealing elements are inserted into a steel mold after processing by cutting and then are rotated to check on the extent to which there is point contact or surface contact. If point contact is observed, follow-up processing is required.

The object of the present invention is to further improve upon a sealing element, intended in particular for a steam head gasket, of the type defined according to the invention such that the manufacturing process is simplified without having to accept any sacrifices in terms of the sealing effect.

According to the invention, this object is achieved essentially by the fact that the contact surface of the unused sealing element has at least one protrusion supportable on the surface to be sealed, functioning as a breaking-in aid.

More than one protrusion may also extend away from the contact surface.

Based on the inventive teaching, after production of the sealing element, no further machining, e.g., by lapping or polishing, is necessary. Instead, because of the at least one protrusion forming a breaking-in aid, a greater sealing effect is achieved with a shorter breaking-in time. The protrusion wears rapidly, so that then surface contact with the opposing running surface to be sealed is achieved, with the result that the desired sealing effect prevails.

According to the invention, in an area of rapid wear on the sealing face, a change in geometry is implemented to ensure at least a linear seal after insertion of the sealing element, developing into a surface seal after a short period of time, this in turn offering the desired sealing effect without requiring expensive reworking or insertion in a gauge and checking the sealing surface after production of the sealing element itself.

In particular this provides for the breaking-in element to be designed to be integral with the base body. However, there is also the possibility of the breaking-in element being designed by adhesive bonding, spraying or as an insert to be introduced into a recess in the base body.

The sealing element should be made of at least one material from the group of carbon graphite, graphite, metals, thermoset plastics, filled thermoset plastics, elastomers, filled elastomers.

The material of the breaking-in element may be the same as that of the sealing element but it may also deviate from the latter.

A method for forming a contact surface of a dynamic sealing element which proceeds from a base body and is in flat contact with a surface to be sealed after breaking-in is characterized in that a dynamic sealing element is used; in the unused state this sealing element has at least one protrusion extending away from the surface to be sealed and supported by the base body, serving as the breaking-in element which is worn to the required extent, in particular completely or almost completely during the breaking-in of the sealing element for surface contact of the contact surface with the surface to be sealed.

Additional details, advantages and features of the invention are derived not only from the claims, the features to be derived from the claims—either alone and/or in combination—but also from the following description of an exemplary embodiment based on the drawings.

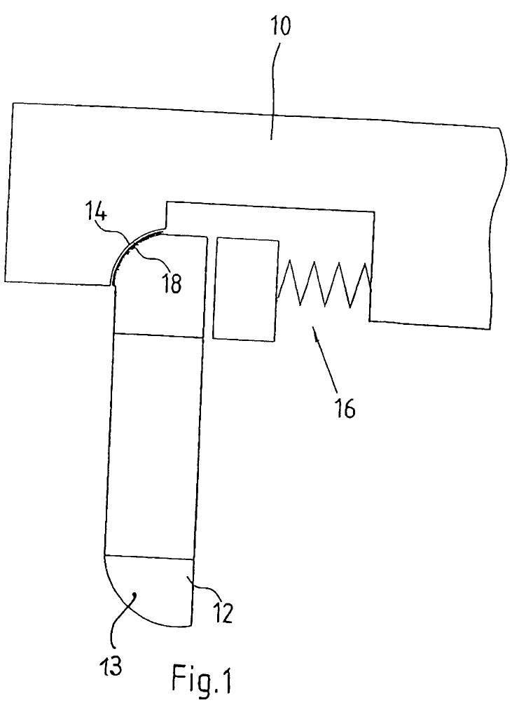

FIG. 1 shows a detail of a housing with a sealing element,

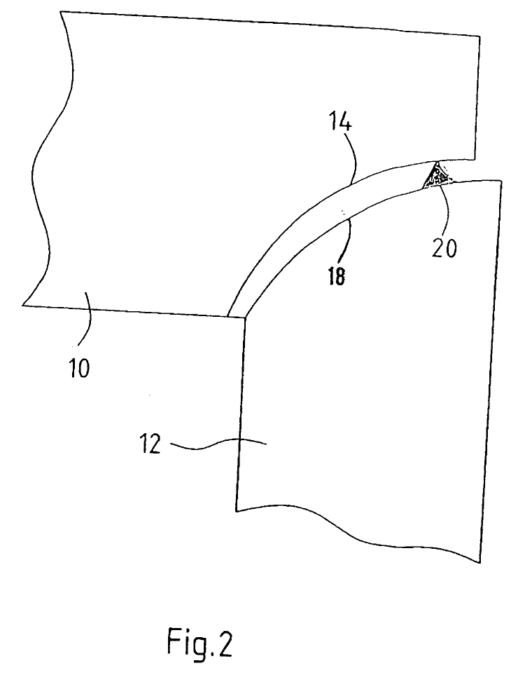

FIG. 2 shows a detail from FIG. 1 in an enlarged diagram.

FIG. 1 shows a detail of a housing 10 in which a shaft (not shown), e.g., of a roller or a drum, is mounted and is sealed with respect to the housing 10 by a dynamic sealing element 12. The sealing element is intended for a steam head gasket or a feeder head gasket in particular to allow sealing with respect to the hot or cold water or heating medium oils. The sealing element 12 has a base body 13 in the form of a ring body in the exemplary embodiment, said ring body being acted upon by force applied by means of a spring arrangement 16 in the direction of a surface 14 of the housing 10 to be sealed, e.g., by means of a spring arrangement 16.

In supplying steam, hot and cold water and heat exchanger oils in revolving drums and rollers, in addition to the rotational movement, vibrational movements, pendulum movements and tumbling movements may also occur. The design of the gasket 12 must thus allow a certain angular movement. This is achieved by the fact that the gasket 12 has a crowned contact surface 18 that has a convex curvature in the present exemplary embodiment. However, the present invention is not limited in this regard. Instead, a concave contact surface may also be used. However, the inventive teaching still applies even to contact surfaces that are designed to be flat, i.e., having neither a convex nor a concave curvature.

To simplify the production of the sealing element 12 without having to accept sacrifices in the sealing effect, it is provided according to the present invention that at least one protrusion 20 extends from the contact surface 18 and consequently protrudes over the contact surface 18. According to the diagram in FIG. 2, the protrusion 20 may be provided in the area of the largest diameter of the sealing element 12. The protrusion 20 may have the geometry of a section of a circle in cross section and may have a height between 0.01 mm and 2 mm, in particular 0.02 mm and 0.5 mm, for example, although these numerical values are not to be interpreted as restrictive. The protrusion 20 may also have the same dimensions in width. Widths between 0.02 mm and 1 mm are to be preferred, however.

In the case of a sealing element having an outside diameter of 100 mm intended for a steam head gasket, the height of the protrusion should be between 0.02 mm and 0.1 mm.

Due to the presence of the protrusion 20, this ensures that when the sealing element 12 is inserted, a sealing effect occurs immediately with respect to the surface 14 to be sealed or the opposing surface. At the same time, there is rapid wear, resulting in a high sealing effect being achieved after only a short breaking-in time. The breaking-in time typically amounts to a few seconds and depends on the material. In particular the breaking-in time amounts to between 1 second and 10 minutes, preferably between 1 second and 60 seconds.

The protrusion 20, which is present only in the unused sealing element 12, consequently serves as a breaking-in aid which is worn off after only a short period of use.

Due to the protrusion 20 that produces the sealing effect already at the beginning of use, it is not necessary after production of the sealing ring 12 to first have to place the sealing ring in a gauge such as a steel mold to ascertain by turning the sealing ring whether the contact surface has a shape within the defined tolerance, i.e., there is surface contact rather than linear contact with the steel mold. If linear contact occurs, then reworking is necessary, e.g. by lapping and polishing.

The dynamic sealing element 12 is made of a material from the group of carbon graphite, graphite, metals, thermoset plastics, filled thermoset plastics, elastomers, filled elastomers. The at least one protrusion 20 protruding above the contact surface 18 of the sealing element 12 prior to use likewise consists of a material of the group mentioned above. However, this does not mean that the protrusion 12 and the base body 13 of the sealing elements 12 must be made of the same material.

It also does not go beyond the scope of the present invention if the at least one protrusion 20 is not produced as an integral part with the base body 13. Instead there is the possibility of manufacturing the at least one protrusion 20 separately and then adhesively bonding it to the contact face 18, for example. Spraying of a material that forms the protrusion 20 is also possible.

According to another proposed approach, one or more receptacles are formed in the contact face, an element forming the protrusion 20 being inserted into these receptacles, exerting the function of the breaking-in aid.

Furthermore, the inventive teaching is not limited to sealing elements which execute a rotational movement. The inventive teaching can also be applied to sealing elements which execute a translational movement.

1. A dynamic sealing element intended in particular for a steam head gasket, with a base body having a contact face, wherein the contact face is in surface contact with a surface to be sealed after being broken in, wherein the contact face of the unused sealing element has at least one broken-in element as a breaking-in aid formed on the surface to be sealed and supportable as a protrusion.

2. The dynamic sealing element according to claim 1, wherein several protrusions protrude away from the contact surface of the base body of the sealing element.

3. The dynamic sealing element according to claim 1, wherein that the breaking-in element is designed as an integral part with the base body.

4. The dynamic sealing element according to claim 1, wherein the breaking-in element is formed by adhesive bonding, spraying, or as an insert to be introduced into a recess in the base body.

5. The dynamic sealing element according to claim 1, wherein the sealing element is made of at least one material selected from the group consisting of carbon graphite, graphite, metals, thermoset plastics, filled thermoset plastics, elastomers, and filled elastomers.

6. The dynamic sealing element according to claim 1, wherein the breaking-in element is made of the same material as the base body.

7. The dynamic sealing element according to claim 1, wherein the material of the breaking-in element deviates from that of the base body.

8. The dynamic sealing element according to claim 1, wherein the breaking-in element is made of at least one material selected from the group consisting of carbon graphite, graphite, metals, thermoset plastics, filled thermoset plastics, elastomers, and filled elastomers.

9. A method for forming a contact surface developing out of a base body as part of a dynamic sealing element, which is in surface contact with a surface to be sealed after being broken in, wherein a dynamic sealing element is used, such that in the unused state it has at least one protrusion that protrudes out of the base body and is supported on the surface to be sealed as a breaking-in element, which is worn down completely or almost completely during the breaking-in of the sealing element for surface contact of the contact face with the surface to be sealed.
